(19) United States
(12) Patent Application Publication
(10) Pub. No.: US 2008/0248256 A1
(43) Pub. Date: Oct. 9, 2008

(54) Transparent Optical Film Comprising Damage Prevention Layer Having Particles Distributed Therein

(75) Inventors: Hyun Jin Kim, Gyeonggi-do (KR); Jong Min Park, Gyeonggi-do (KR); Chang Gun Kim, Gyeonggi-do (KR); Ji Seong Kim, Seoul (KR); Woo Chul Jung, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: KOLON IND. INC./KR

(21) Appl. No.: 10/593,012

(22) PCT Filed: Mar. 18, 2005
(86) PCT No.: PCT/KR2005/000795

§ 371 Date: Feb. 1, 2008

(30) Foreign Application Priority Data
Mar. 19, 2004 (KR) 10-2004-0019001

(51) Int. Cl. B32B 3/00

(52) U.S. Cl. 428/172

(57) ABSTRACT

Disclosed herein is a transparent optical film, including an optically structured layer, which is a sheet formed of a transparent polymeric material and composed of a first surface having three-dimensional structures thereon and a second surface opposite the first surface, and a damage prevention layer formed on the second surface of the optically structured layer and composed of a transparent polymeric material and spherical organic or inorganic particles. The damage prevention layer has protruding surface portions formed by the particles protruding from the transparent polymeric material. The optical film of the current invention is advantageous because the prism structure and the opposite surface of the optical film are prevented from damage due to external impact, vibration and friction, and the attachment of impurities due to frictional static charges is prevented. Further, the front luminance and optical properties of the optical film are improved.

### TECHNICAL Field

The present invention relates, in general, to an optical film for use in a liquid crystal display (LCD), and, more particularly, to a transparent optical film, which is used in a backlight unit of an LCD to increase the efficiency of light transfer from a light source to an LCD panel, thus increasing the luminance of an image reproduced on the screen and realizing a uniform image of high quality over the entire screen.

### BACKGROUND ART

As industrialized society has been developed towards a high information age, electronic display devices have become increasingly important as a medium for displaying and transferring various pieces of information. Although a CRT (Cathode Ray Tube) is typically used in the electronic display device, limitations are imposed on manufacturing the CRTs at large sizes because the space to mount bulky CRTs is difficult to provide. Thus, such a CRT tends to be replaced with various flat displays, such as LCDs, plasma display panels (PDPs), field emission displays (FEDs) and organic electroluminescent (El) devices. In particular, since the LCD obtained by the combination of liquid crystal-semiconductor techniques is advantageous in terms of being thin and light and having low power consumption, thorough research into structures and manufacturing techniques of LCDs has been conducted. Nowadays, the LCDs, which have been already applied to medium or small sized display devices, such as notebook computers, monitors of desktop computers, portable personal communication devices (PDA, mobile phones, etc.), are manufactured to be large so that LCDs are applied to large sized televisions including high definition (HD) televisions. The LCD is receiving attention as a novel substitute for CRTs that have become a synonym for display device.

In the LCD, since the liquid crystal per se cannot emit light, an additional light source is installed to the rear of the device, and the intensity of light passing through liquid crystals in each pixel is controlled to represent contrast. Specifically, the LCD, which is a device controlling light transmittance using electrical properties of liquid crystal materials, is used to pass light emitted from the light source lamp installed to the rear of the device through various functional optical films or sheets to cause light to be directional and uniform, followed by passing such controlled light through a color filter, thereby realizing red, green and blue (RGB) colors. Further, the LCD is an indirect light emission type display device which is able to realize the image by controlling the contrast of each pixel using electrical methods. As such, a light emission diode provided with the light source is important in determining the quality of the image such as luminance and uniformity of the LCD.

The light emission diode is exemplified by a backlight unit. A general backlight unit is shown in FIG. 1. As shown in FIG. 1, the backlight unit 1 using a light source 2a such as a cold cathode fluorescent lamp (CCFL) allows light emitted from the light source 2a to sequentially pass through a light plate 2d, a diffusion sheet 2e and prism sheets 2f and 2g to reach a liquid crystal panel 3. In the backlight unit 1, the light plate 2d functions to transfer light emitted from the light source to the entire surface of the planar liquid crystal panel 3, and the diffusion sheet 2e serves to exhibit uniform light intensity over the entire surface of the screen. In addition, the prism sheets 2f and 2g perform the light path control function to transform various directions of light beams passed through the diffusion sheet 2e in a range of viewing angles (θ) suitable for viewing the image. Further, a reflection plate 2c is provided on a bottom surface of the light plate 2d, so that light which falls out of the optimal light path and thus is not transferred to the liquid crystal panel is reflected again and reused, thereby increasing the light efficiency.

For the viewer positioned in front of the screen, the prism sheets 2f and 2g function to control the paths of light diffused to various directions by passing through the diffusion sheet 2e to increase the front luminance of the display, realizing brighter and clearer images.

U.S. Pat. Nos. 2,248,638, 4,497,860, 4,805,984 and 4,906,070, and Korean Patent Application No. 1986-0009868 disclose an optical film or sheet having a linear array of a plurality of prisms on one side. FIG. 2 shows the structure of a conventional prism sheet 10. As shown in FIG. 2, the conventional prism sheet 10 is formed of a transparent material, and has a regular array of prisms 12 on one surface. The prisms 12 may be formed in a linear array shown in FIG. 2. Alternatively, a pyramidally structured prism 22 may be used, which is illustrated in FIG. 3. In addition, various arrays of prisms of which the shapes and structures are changed have been proposed.

FIG. 4 is a view explaining the light path control function of the conventional prism sheet 10. As shown in FIG. 4, light entered from the lower portion of the prism sheet 10 is divided into light having a path A in which light is refracted depending on the incident angle (α1) and radiates upward, or light having a path B or C in which light is totally reflected and radiates downward. The light having a path B or C is then reflected again through the reflection plate 2c of FIG. 1 to be reused, or falls outside of the viewing angle (θ) and is not used in the LCD panel to be lost.

The optical film having a plurality of prisms 12 arranged linearly as shown in FIG. 2 may further increase the forward light path control when being laminated in twos than when being used individually. As such, the lamination is carried out by orthogonally arranging the two prism sheets or orienting them at a predetermined angle. In U.S. Pat. No. 4,542,449, a laminate of two optical films usable as the prism sheets is described. In these days, the orthogonal arrangement of the two prism sheets 2f and 2g as shown in FIG. 1 is commonly used. The optical film disclosed in U.S. Pat. No. 4,542,449 includes a structured surface having a linear array of a plurality of isosceles prisms and an opposite smooth surface, while the perpendicular sides of the isosceles prisms form an angle of approximately 45° with the smooth surface. Such a prism sheet is orthogonally arranged with another prism sheet and laminated as in FIG. 1, thereby realizing polarizability and high front luminance.

By forming the array of prisms on a transparent curing resin layer that is applied on a transparent film formed of polyester and polycarbonate, the optical film is manufactured into a roll or large area sheet, cut into sizes and shapes suitable for being mounted to the device and then mounted to the backlight unit frame of the LCD in such a way that two films are orthogonally arranged. As such, the two laminated prism sheets are present in the state of the smooth surface of the upper prism sheet coming into contact with the vertices of the prisms of the lower prism sheet.

However, when the two prism sheets are laminated, the prism structure may be worn due to impact or vibration during the manufacturing process or when using the LCD. In addition, the smooth surface of the upper sheet may be scratched due to contact with the vertices of the prisms of the lower sheet. As for manufacturing the film, the prism structure may be damaged due to surface friction with the film loading device, and due to friction between the prism films when separating the respective loaded optical films. In particular, the smooth surface may be easily damaged.

The material generally used for the prism film, such as polyethyleneterephthalate or polycarbonate, has relatively low surface hardness, and causes severe damage. Moreover, the likelihood of impurities becoming attached to the smooth surface due to static charges caused by friction during transport or assembly is increased. Thus, the damage to the prism structure or smooth surface or attachment of impurities results in formation of non-uniform shapes or images when transmitting light. Thereby, it is impossible to realize a uniform and clear image, causing high defect rates.

### DESCRIPTION OF DRAWINGS

FIG. 1 is a sectional view showing a conventional LCD;

FIG. 2 is a perspective view showing a conventional optical film;

FIG. 3 is a perspective view showing another conventional optical film;

FIG. 4 is a view showing the optical function of the conventional optical film;

FIG. 5 is a perspective view showing an optical film, according to a first embodiment of the present invention;

FIG. 6 is a perspective view showing an optical film, according to a second embodiment of the present invention;

FIG. 7 is a sectional view showing two optical films of the present invention, which are orthogonally arranged and laminated;

FIG. 8 is a sectional view showing the optical film of the present invention, which is placed on a table;

FIG. 9 is a sectional view showing the conventional arrangement of two optical films, which are orthogonally arranged and laminated;

FIG. 10 is a view showing the improved optical function of the optical film of the present invention; and

FIG. 11 is a view showing the improved optical function of the optical film of the present invention.

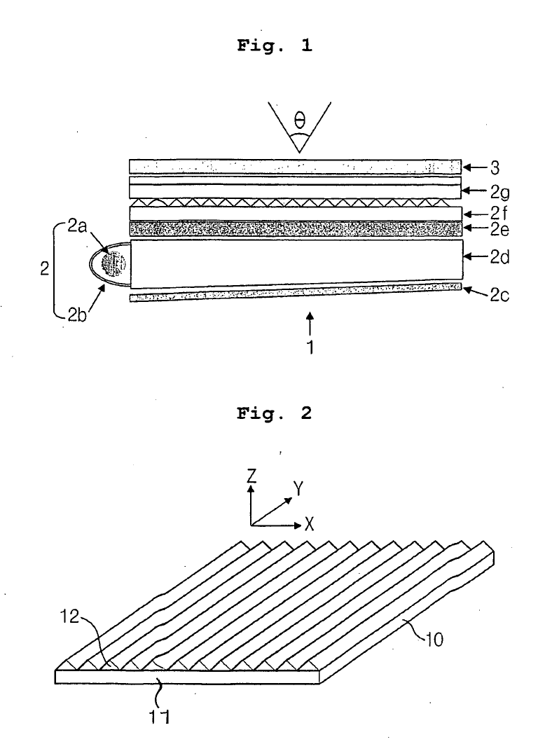

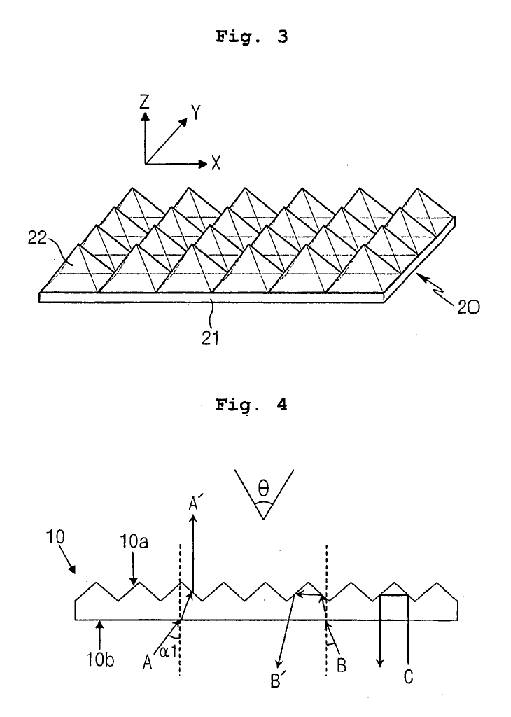

### DISCLOSURE

### Technical Problem

The present invention has been made keeping in mind the above problems occurring in the prior art, and an object of the present invention is to provide a transparent optical film having an improved prism structure, usable as a prism sheet, which functions to prevent the prism structure and the other surface of the optical film from damage due to external impact, vibration and friction, and also, to prevent the attachment of impurities due to frictional static charges.

Another object of the present invention is to provide a transparent optical film, which has improved optical properties, such as front luminance.

### Technical Solution

In order to accomplish the above object(s), the present invention provides an optical film, which comprises an optically structured layer, which is a sheet formed of a transparent polymeric material and includes a first surface on which a plurality of three-dimensional structures is formed and a second surface opposite the first surface; and a damage prevention layer, which is formed on the second surface of the optically structured layer and is composed of a transparent polymeric material and a plurality of spherical organic or inorganic particles distributed in the transparent polymeric material, wherein the damage prevention layer has protruding surface portions which are formed by the spherical organic or inorganic particles protruding from the transparent polymeric material.

Preferably, the optically structured layer includes a base layer, which is formed as a flat sheet to constitute the second surface of the optically structured layer, and a structured layer, which comes into contact with the base layer and is formed of a curing resin to constitute the first surface of the optically structured layer.

### BEST MODE

Reference should now be made to the drawings, in which the same reference numerals are used throughout the different drawings to designate the same or similar components.

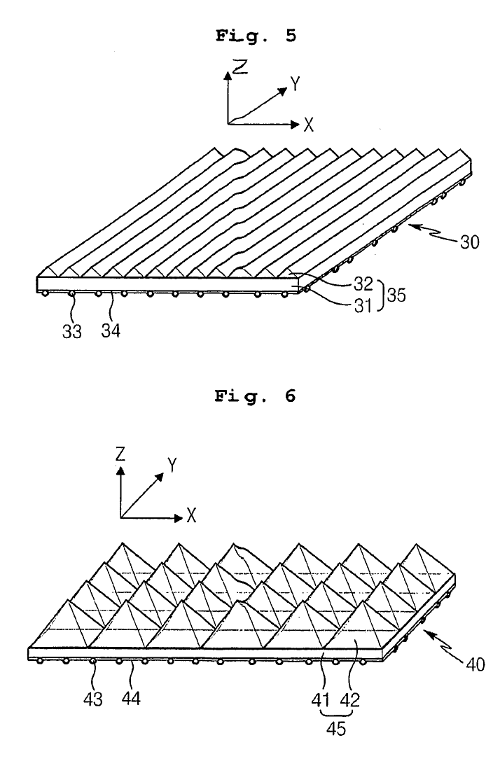

FIG. 5 shows a structure of an optical film, according to a first embodiment of the present invention. As shown in FIG. 5, a prism sheet 30 includes an optically structured layer 35 having a linear array of a plurality of isosceles prisms arranged side-by-side on one surface to collect light and increase luminance, and a damage prevention layer 34 on the opposite surface. As such, the damage prevention layer 34 has organic or inorganic particles 33 distributed therein.

FIG. 6 shows a structure of an optical film, according to a second embodiment of the present invention. As shown in FIG. 6, a prism sheet 40 is composed of an optically structured layer 45 having a regular array of a plurality of pyramidal prisms on one surface, unlike the prism sheet 30 shown in FIG. 5. The structure formed on one side of the optically structured layer 35 or 45, which includes a linear array of a plurality of isosceles prisms shown in FIG. 5 or an array of pyramidal prisms shown in FIG. 6, may consist of various arrays, such as an array of conical prisms, an array of semi-spherical prisms, or an array of non-spherical prisms (e.g., an array of pentagonal-, hexagonal-, octagonal-, oval-spherical prisms), as necessary.

The optically structured layer 35 or 45 includes a base layer 31 or 41 formed as a flat sheet, and a structured layer 32 or 42 in contact with the base layer 31 or 41. The base layer 31 or 41 and the structured layer 32 or 42 may be individually formed in a laminate of at least one layer. Alternatively, the optically structured layer 35 or 45 may be integrally formed, without being divided into the base layer 31 or 41 and the structured layer 32 or 42. In consideration of the mechanical strength of film and the convenience of a manufacturing process, a structure including the base layer 31 or 41 and the structured layer 32 or 42 formed of a curing resin thereon is preferably used.

In this case, the base layer 31 or 41 may be formed of any plastic material so long as it has high light transmittance. The base layer material includes, for example, polycarbonate, polypropylene, polyethyleneterephthalate, polyethylene, polystyrene, epoxy resin, etc. Of these materials, polycarbonate or polyethyleneterephthalate is preferable. The material constituting the base layer 31 or 41 should have adhesion to the curing resin that is to be applied thereon to form the structured layer 32 or 42, and also, should have high light transmittance, with uniform surface smoothness to have no partial luminance variation.

In addition, the base layer 31 or 41 is formed to a thickness of 10 to 1000 μm. If the thickness of the base layer 31 or 41 is less than 10 μm, mechanical strength and heat stability may be decreased. Meanwhile, if the thickness exceeds 1000 μm, the flexibility of the film is lowered, and the loss of the transmitted light may be generated. Thus, the base layer 31 or 41 is preferably formed in the thickness range from 25 to 500 μm.

On the base layer 31 or 41 formed of a transparent plastic material, the structured layer 32 or 42 is formed, which consists of an optically structured array to increase the front luminance using a transparent curing resin having a refractive index higher than the material constituting the base layer 31 or 41.

The structured layer 32 or 42 includes optically structured arrays having various shapes, for example, a linear array of miniature isosceles prisms arranged side-by-side, as apparent from FIG. 5. As such, when the vertex angle of the prism structure (angle between two inclined surfaces of the prism) is defined as α, α is determined in the range of from 20 to 140°. Since the optical properties, such as front luminance and light intensity distribution in the viewing angle, vary with the vertex angle (α) of the isosceles prism, the vertex angle of the prism is preferably in the range of from 80 to 100°. When the vertex angle of the prism is less than 80°, the front luminance increases due to the light collection, however, the light intensity distribution in the viewing angle becomes poor. On the other hand, if the vertex angle exceeds 100°, although the light intensity distribution in the viewing angle becomes good, the front luminance decreases. Hence, it is more preferable that the vertex angle of the prism be in the range of from 85 to 95°.

The material constituting the structured layer 32 or 42 includes a polymeric resin, such as a UV curing resin or a heat-curing resin, for example, unsaturated fatty acid ester, aromatic vinyl compound, unsaturated fatty acid and derivatives thereof, unsaturated dibasic acid and derivatives thereof, vinyl cyanide such as methacrylonitrile, etc. Further, it is preferable that the material constituting the structured layer 32 or 42 has a refractive index higher than the material constituting the base layer 31 or 41. In the case where the base layer 31 or 41 has a higher refractive index, the light passing through the rear surface of the base layer 31 or 41 is totally reflected at the interface between the base layer 31 or 41 and the structured layer 32 or 42, and thus, may not enter the prism structure.

The damage prevention layer 34 or 44 is formed beneath the optically structured layer 35 or 45. The damage prevention layer 34 or 44 has protruding surface portions which are formed by the particles 33 or 43 distributed therein. The protruding surface portions of the damage prevention layer 34 or 44 function to reduce the area coming into contact with the facing surface in the process device, or with another optical film to be laminated when loading or storing the optical films or assembling the optical films with other components. Thereby, surface damage, which may be caused by separation into respective films, transportation or assembly, is prevented.

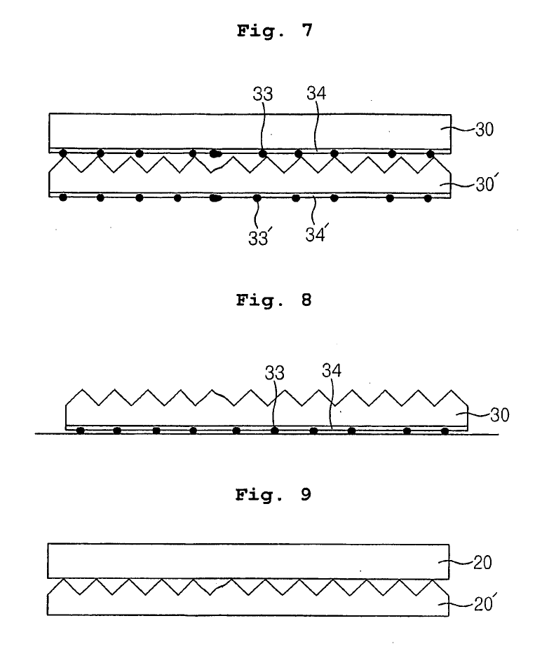

That is, in the case where the laminate of two optical films is used in the backlight unit, the protruding surface portions of the damage prevention layer 34 or 44 of one optical film come into contact with the other optical film, while inhibiting direct contact between vertices of prisms of one optical film and the smooth surface of another optical film as in the conventional film shown in FIG. 9, thus decreasing the contact area between the optical films, and exhibiting the cushioning functions using the particles. In this way, the surface damage is prevented by means of the structure for preventing the damage to the vertices of the prisms on the structured surface or damage to the smooth surface opposite the structured surface. FIG. 7 shows the case in which the surface damage is prevented due to the decreased contact area between two optical films 30 and 30′ laminated together, according to the present invention. FIG. 8 shows the case in which surface damage is prevented due to the decreased contact area when the optical film is placed on a table.

The damage prevention layer 34 or 44 is formed of organic or inorganic particles dispersed in a transparent organic binder resin. The binder resin should be highly adherent to the material constituting the base layer 31 or 41, and have high compatibility with the particles to the extent that the particles are uniformly dispersed in the resin so as not to be separated or precipitated.

The binder resin includes, for example, acrylics, such as unsaturated polyester, methylmethacrylate, ethylmethacrylate, isobutylmethacrylate, n-butylmethacrylate, n-butylmethylmethacrylate, acrylic acid, methacrylic acid, hydroxyethylmethacrylate, hydroxypropylmethacrylate, hydroxyethylacrylate, acrylamide, methylolacrylamide, glycidylmethacrylate, ethylacrylate, isobutylacrylate, n-butylacrylate, 2-ethylhexylacrylate polymers, copolymers or terpolymers, as well as urethane-, epoxy-, or melamine-based resins. To increase heat resistance, wear resistance and adhesion, a curing agent is used, obtaining a hard resin film.

The particles, which are dispersed in the binder resin to form the damage prevention layer 34 or 44, are composed of organic or inorganic particles. Typically used organic particles include, for example, acrylics such as methylmethacrylate, acrylic acid, methacrylic acid, hydroxyethylmethacrylate, hydroxypropylmethacrylate, acrylamide, methylolacrylamide, glycidylmethacrylate, ethylacrylate, isobutylacrylate, n-butylacrylate, or 2-ethylhexylacrylate polymers, olefins such as polyethylene, polystyrene, or polystyrene, acryl-olefin copolymers, or multi-layered multicomponent particles formed by covering homopolymer particles with another type of monomer.

Inorganic particles, which are exemplified by silicon oxide, aluminum oxide, titanium oxide, zirconium oxide, magnesium fluoride, etc., may be used. The above-mentioned organic particles and inorganic particles are merely provided to be illustrative, and the present invention is not limited thereto. In addition, other particulate material well known to those skilled in the art may be used so long as it achieves the object of the present invention. The change of the particulate material is incorporated in the scope of the present invention.

Although varying with the thickness of the damage prevention layer, the size (diameter) of the particles distributed in the damage prevention layer is in the range of from 0.1 to 20 μm. When the particles are too large, the vertices of the prisms may be damaged due to the protruding surface portions of the damage prevention layer. Conversely, when the particles are too small, it is difficult to exhibit damage prevention effects. Preferably, particles having a size of 0.1 to 15 μm are used. In addition, the particles have a monodispersed size distribution. If the size variation of the particles is extremely large, the protruding surface portions of the damage prevention layer 34 or 44 have heights varying with their positions, thus deteriorating structural and optical uniformity. Therefore, the use of particles having a small standard deviation from an average size is preferable.

In the damage prevention layer 34 or 44 of the optical film, the particles should not have too high a density, and should not be completely embedded. As schematically shown in FIGS. 5 to 8, 10 and 11, the particles should not be densely distributed in the damage prevention layer 34 or 44. When the density of the particles is extremely high, the particles may partially agglomerate, or other particles may be stacked on the distributed particles. Thus, the particles should be spaced at predetermined intervals apart from each other. That is, the particles are preferably formed in an island structure or monolayer structure similar to the initial state of the film to be formed on the base layer using deposition.

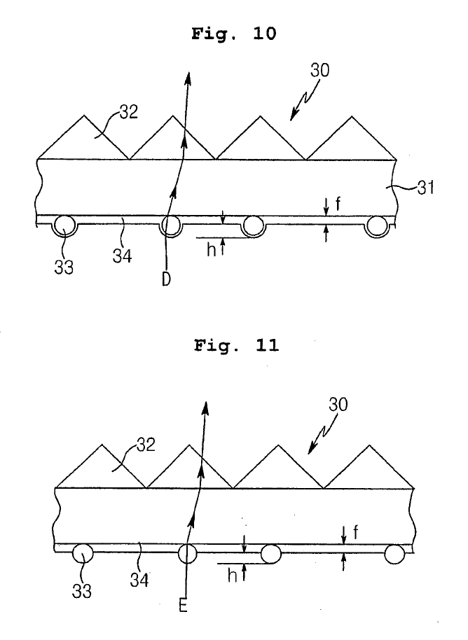

Therefore, since the above exemplary structure is preferably used, the size distribution of the particles is limited in consideration of the thickness of the portions of the damage prevention layer 34 having no particles. FIGS. 10 and 11 illustrate the distribution states of the particles in the damage prevention layer 34. In FIG. 10, the island structure, in which the particles 33 are formed in the island structure in the damage prevention layer 34 beneath the base layer 31, is illustrated. As in FIG. 10, the binder resin is formed into a thin film in such a way that the protruding surface portions of the damage prevention layer 34 are covered with the above resin. In addition, as shown in FIG. 11, the particles are partially externally exposed from the binder resin. The structures shown in FIGS. 10 and 11 may be simultaneously formed at different positions on the same optical film. When the protruding surface portions of the damage prevention layer 31 have an excessively large height h, they negatively affect the vertices of the prisms, or may be separated or may break down. Thus, the protruding surface portions of the damage prevention layer 34 have a height h not exceeding 50% of the diameter of the particles. To obtain an ideal particle distribution, the thickness f of the portions of the damage prevention layer 34 having no particles 33 should range from 50% to less than 100% of the diameter of the particles. If the above thickness of the damage prevention layer 34 is too large, the particles 33 are completely embedded therein, and hence, it is difficult to form the protruding surface portions of the damage prevention layer desired in the present invention, thus not obtaining the island structure or monolayer structure. The thickness of the damage prevention layer 34 is controlled by adjusting the amount of binder resin included in the coating composition and the amount of coating composition composed of the binder resin having particles dispersed therein.

To obtain the structure of the damage prevention layer 34 mentioned above, the binder resin having particles dispersed therein is applied on the bottom surface of the base layer 31. As such, the organic or inorganic particles are used in an amount of 0.1 to 100 parts by weight, based on 100 parts by weight of the organic binder. When a large amount of the organic or inorganic particles are used, the organic particles function to decrease the front luminance due to light diffusion, and the inorganic particles function to decrease the front luminance due to light reflected from the surface of particles or absorbed thereto, thus the light efficiency may be decreased. For easy formation of the island structure or monolayer structure, the organic or inorganic particles are preferably used in an amount of 1 to 50 parts by weight, based on 100 parts by weight of the organic binder. Thereby, light scattering or light diffusion is minimized by means of the island or monolayer structure of the particles, resulting in sufficient front luminance.

Further, the particles used in the present invention have a refractive index of 1.4 to 1.5. When the refractive index of the particles is excessively high, the light passing through the particles in the structures of FIGS. 10 and 11 is totally reflected at the boundaries between the particles and the binder resin layer, and thus, the front luminance may be lowered. As shown in FIGS. 10 and 11, the particle distribution of the present invention affects the path of light entering the base layer 31 to increase the front luminance. In particular, of light entering the base layer 31, incident light perpendicular to the film is present in a large quantity when considering the general structure of the backlight unit shown in FIG. 1. In the conventional optical film shown in FIG. 4, incident light C perpendicular to the film is totally reflected from the surface of the prism and faces backward, and then reflected again from the reflection plate 2c and passed through the diffusion sheet 2e. As such, loss of light occurs. However, in the present invention, as seen in FIGS. 10 and 11, the paths of incident light D and E perpendicular to the film are changed by the particle distribution, and thus, light is not totally reflected from the surface of the prism. Thereby, it appears that the front luminance is increased due to the particle distribution of the present invention.

Moreover, the damage prevention layer 34 of the present invention further includes an antistatic agent to prevent contamination due to dust or impurities when manufacturing the backlight unit, in addition to the binder resin and the particles. The use of the antistatic agent leads to reduced static charges, thus preventing the attachment of impurities and increasing the quality of the image. The antistatic agent includes, for example, quaternary amine-, anionic-, cationic-, nonionic-, or fluoride-based materials.

### MODE FOR INVENTION

A better understanding of the present invention may be obtained through the following examples which are set forth to illustrate, but are not to be construed as the limit of the present invention.

### EXAMPLE 1

90 parts by weight of acrylic polyol and 10 parts by weight of isocyanate were dissolved in 300 parts by weight of methylethylketone and 200 parts by weight of toluene. 10 parts by weight of polymethylmethacrylate (PMMA) particles (average diameter 5 μm, monodispersed particles) and 2 parts by weight of quaternary amine-based antistatic agent were dispersed in the above solution. Subsequently, the obtained solution was applied on one surface of a 125 μm thick base film formed of polyethyleneterephthalate using gravure, and dried at 100° C. for 30. sec, to prepare a sheet including a damage prevention layer composed of 6 μm thick portions in which particles were distributed and 4 μm thick portions in which no particles were distributed.

A mixture of 95 parts by weight of an acryl-based UV curing resin and 5 parts by weight of a light initiator was applied on the surface opposite the damage prevention layer of the sheet, and exposed to UV, to manufacture an optical film having a linear array of right angled isosceles prisms arranged side-by-side in which the prisms were spaced at intervals of 50 μm and had heights of 25 μm.

### EXAMPLE 2

90 parts by weight of acrylic polyol and 10 parts by weight of isocyanate were dissolved in 300 parts by weight of methylethylketone and 200 parts by weight of toluene. 20 parts by weight of PMMA particles (average diameter 5 μm, monodispersed particles) and 2 parts by weight of quaternary amine-based antistatic agent were dispersed in the above solution. The subsequent processes were performed in the same manner as in Example 1, to manufacture an optical film.

### EXAMPLE 3

90 parts by weight of acrylic polyol and 10 parts by weight of isocyanate were dissolved in 300 parts by weight of methylethylketone and 200 parts by weight of toluene. 20 parts by weight of PMMA particles (average diameter 5 μm, monodispersed particles) and 2 parts by weight of quaternary amine-based antistatic agent were dispersed in the above solution.

Subsequently, unlike Example 1, the obtained solution was applied on one surface of a 125 μm thick base film formed of polyethyleneterephthalate using gravure, and dried at 100° C. for 30 sec, to prepare a sheet including a damage prevention layer composed of 6 μm thick portions in which particles were distributed and 2 μm thick portions in which no particles were distributed. In addition, on the surface opposite the damage prevention layer of the sheet, a mixture of 95 parts by weight of an acryl-based UV curing resin and 5 parts by weight of a light initiator was applied, and exposed to UV, to manufacture an optical film having a linear array of right angled isosceles prisms arranged side-by-side in which the prisms were spaced at intervals of 50 μm and had heights of 25 μm.

### COMPARATIVE EXAMPLE 1

An optical film was manufactured in the same manner as in Example 1, with the exception that a prism structure the same as that of Example 1 was applied on the base film while the damage prevention layer was not formed thereon.

### COMPARATIVE EXAMPLE 2

A transparent prism sheet product (trade name: BEFII) having a linear prism array, available from 3M (Minnesota Mining and Manufacturing Co. Ltd., USA), was used.

The properties of the optical films obtained in Examples and Comparative Examples were measured in accordance with the following procedures.

(1) Luminance (cd/cm²)

The two prism sheets, which were orthogonally arranged and Laminated, were mounted to a backlight unit (Model: LM170EO1, Heesung Electronics Ltd., Korea) for a 17 inch LCD panel, luminance at 13 spots was measured using a luminance meter (Model: BM7, Topcon Co. Ltd., Japan), and the obtained values were averaged.

(2) Surface Resistance

The resistance value was determined using a surface resistance measuring system (KEITHLEY238, KEITHLEY Co. Ltd.)

(3) Friction Force

The passive/active friction coefficients were measured.

(4) Damage to Vertex of Prism

To the two optical films orthogonally arranged and laminated, a predetermined impact was applied using a vibration tester. Then, the number of damaged prisms per 1 cm² area was counted using an electron scanning microscope.

The results are shown in Table 1, below.

TABLE 1

| | Satisfy | | | | | |
|---|---|---|---|---|---|---|
| Properties | Standard | Ex. 1 | Ex. 2 | Ex. 3 | C. Ex. 1 | C. Ex. 2 |
| Luminance (cd/cm²) | — | 1980 | 1985 | 1985 | 1975 | 1977 |
| Surface Resistance (Ω) | 10¹² or less | 10¹¹ | 10¹¹ | 10¹¹ | 10¹⁵ | 10¹⁵ |
| Friction Coefficient | 0.4 or less | 0.4 | 0.4 | 0.4 | 0.6 | 0.5 |
| No. of Damaged Prisms | No Damage | 0 | 0 | 7 | 8 | 7 |

As is apparent from Table 1, the optical films obtained in Examples 1 to 3 have luminance higher than films of Comparative Examples 1 and 2, and also, have surface resistance less than the standard value of 10¹². Further, since the friction coefficients of the optical films prepared in Examples are 0.4 or less, the prism is expected to be damaged less, unlike Comparative Examples. Actually, no damage to the vertices of the prisms was observed. In Example 3, it is believed that the vertices of the prisms were damaged by the highly protruding surface portions of the damage prevention layer.

Although the optical films according to the preferred embodiments of the present invention have been disclosed for illustrative purposes, those skilled in the art will appreciate that various modifications, additions and substitutions thereof are possible, without departing from the scope and spirit of the invention as disclosed in the accompanying claims.

### INDUSTRIAL APPLICABILITY

As described above, the present invention provides a transparent optical film having a damage prevention layer in which particles are dispersed, thus realizing the original performance of a conventional prism sheet and preventing surface damage due to friction, impact and vibration during the manufacturing process, or due to contact when two films are laminated.

Since the contact area of the laminated optical films is decreased by the protruding surface portions of the damage prevention layer disposed on the rear surface of the above film, friction may be reduced, creating minimal static charges. When the damage prevention layer having particles dispersed therein additionally includes the antistatic agent, the generation of static charges may be further reduced. Thereby, it is possible to improve images having low quality due to the attachment of impurities.

Further, the light path is controlled due to the particles of the damage prevention layer being disposed on the rear surface of the optical film, increasing the front luminance.

Therefore, the prism film thus manufactured has low defect rates, and prevents damage or attachment of impurities thereto when being assembled in LCDs, realizing uniformity and good image quality.

1. An optical film, comprising:
an optically structured layer, which is a sheet formed of a transparent polymeric material and includes a first surface on which a plurality of three-dimensional structures are formed and a second surface opposite the first surface; and
a damage prevention layer, which is formed on the second surface of the optically structured layer and is composed of a transparent polymeric material and a plurality of spherical organic or inorganic particles distributed in the transparent polymeric material,
wherein the damage prevention layer has protruding surface portions which are formed by the spherical organic or inorganic particles protruding from the transparent polymeric material.

2. The method according to claim 1, wherein the optically structured layer includes a base layer, which is formed as a flat sheet to constitute the second surface of the optically structured layer, and a structured layer, which comes into contact with the base layer and is formed of a curing resin to constitute the first surface of the optically structured layer.

3. The method according to claim 1, wherein the three-dimensional structure of the first surface of the optically structured layer includes any one selected from the group consisting of a parallel array of linear isosceles prisms arranged side-by-side, an array of pyramidal prisms, an array of conical prisms, an array of semi-spherical prisms, and an array of non-spherical prisms.

4. The method according to claim 2, wherein the base layer is formed of any one selected from the group consisting of polyethyleneterephthalate, polycarbonate, polypropylene, polyethylene, polystyrene, and epoxy resins.

5. The method according to claim 1, wherein the spherical particles are monodispersed in the damage prevention layer and have an average diameter of 0.1 to 15 μm.

6. The method according to claim 1, wherein the spherical particles include any one selected from the group consisting of acrylics, olefins, acryl-olefin copolymers, and multilayered multicomponent particles.

7. The method according to claim 1, wherein the spherical particles include any one selected from the group consisting of silicon oxide, aluminum oxide, titanium oxide, zirconium oxide, and magnesium fluoride.

8. The method according to claim i, wherein the spherical particles of the damage prevention layer are used in an amount of 20 wt % or less, based on the weight of the transparent polymeric material.

9. The method according to claim 1, wherein the protruding surface portions of the damage prevention layer are formed to have a height corresponding to 50% or less of the diameter of the spherical particles.

10. The method according to claim 1, wherein the spherical particles are formed of a material having a refractive index of 1.4 to 1.5.

11. The method according to claim 1, wherein the damage prevention layer, with the exception of the protruding surface portions of the damage prevention layer, are formed to have a thickness corresponding to the range of from 50% to less than 100% of the diameter of the particles.

12. The method according to claim 1, wherein the spherical particles of the damage prevention layer are distributed in a monolayer structure.

13. The method according to claim 1, wherein the damage prevention layer further comprises an antistatic agent.

14. The method according to claim 13, wherein the antistatic agent includes any one selected from the group consisting of quaternary amine-based materials, anionic-based materials, cationic-based materials, nonionic-based materials, and fluoride-based materials.
